(19) United States
(12) Patent Application Publication
(10) Pub. No.: US 2010/0296900 A1
(43) Pub. Date: Nov. 25, 2010

(54) AGRICULTURAL BALE HANDLING DEVICES AND METHODS

(76) Inventor: Angus James Tocher, Calgary (CA)

Correspondence Address: Lambert Intellectual Property Law, Suite 200, 10328 - 81 Avenue, Edmonton, AB, T6E 1X2, CA

(21) Appl. No.: 12/469,067

(22) Filed: May 20, 2009

(51) Int. Cl. A01D 90/10

(52) U.S. Cl. 414/24.6; 414/812

(57) ABSTRACT

An agricultural bale handling device is disclosed, comprising: a frame comprising a pair of side arms laterally spaced by a front connector to receive the circular ends of a round agricultural bale; each side arm having a gripping element, connected to the respective side arm, in which the gripping element of one side arm is directed towards the gripping element of the other side arm for engaging respective circular ends of the bale between the side arms to mount the bale for rotation relative to the frame. A method of transporting an agricultural bale is also disclosed, comprising: mounting the circular ends of a bale for rotation between a pair of side arms of a frame, in which the pair of side arms are laterally spaced by a front connector of the frame; and moving the bale along a surface by towing the frame.

### TECHNICAL FIELD

This document relates to agricultural bale handling devices and methods.

### BACKGROUND

Round agricultural bales used as feed for livestock such as cows, horses and sheep, and round straw bales used as bedding for these animals are typically handled with the front-end loader of a tractor, with the three-point hitch at the back of the tractor or with specialized equipment developed for pick-up trucks. The ‘bale-handlers’ for pick-up trucks are used for picking up round bales of hay or straw and moving them off of the field that they were baled on, or for moving round bales into a location where they will be fed or used as bedding. This equipment is complex, usually involving hydraulics and may cost several thousands of dollars.

The smaller rectangular or ‘square’ bales of hay as they are known, those that may weigh 50 to 80 lbs are generally significantly more expensive pound for pound than round bales that may weigh from 1,200 to 1,800 lbs. This is because the production of ‘square’ bales is more labour intensive and the bales need to be removed from the field and stacked and tarped or shedded soon after baling otherwise they are at risk of damage from rain. Round bales are better able to shed rain water because the hay is wound into a bale effectively forming a thatched roof covering on each bale. As well, square bales may be difficult to obtain and transport, and therefore many horse owners have had to switch from the more convenient size of square bales, to the much larger and heavier round bales for feeding. The use of round bales however requires that the horse owners have access to a tractor, purchased, borrowed or otherwise obtained for handling large round bales. Most horse owners have a truck with a ball-hitch for pulling their horse trailers. Therefore a need exists for a device and method for handling round bales whereby the bale may be attached to a device that may then be hitched to a vehicle having a trailer hitch, or even rigged to a horse, and then the bale rolled from one location to another without the use of an expensive tractor having a front-end loader or other attachments for handling round bales.

The rancher as well may need to feed round bales to his livestock during the winter months and other times when pastures are unavailable. Typically a tractor is used for this operation having a specialized attachment to the 3-point hitch at the rear of the tractor. This attachment uses hydraulics to lift the bale. The rancher then drives the tractor with the bale to the area in which he wishes to feed, then lowers the attached bale onto the ground. The twine that is wrapped around the bale holding it together is then cut and the tractor moved forward unraveling the bale as it progresses, leaving the bale in a strip on the field that his livestock can access. Each time the rancher needs to feed his livestock, he must take the tractor out to the bale stack where the bales are retrieved for feeding. In colder climates, typically, ranchers keep their livestock closer into the farm area so that the tractor can be kept in a building with the block heater plugged in and the tractor reasonably close to where the livestock are to be fed. A need therefore exists again for a device and method for feeding out hay bales, or spreading out straw bedding for animals by which a truck or other vehicle or horse may be hitched to the device rather than by use of a tractor. This device would also permit the rancher to keep and feed his livestock at greater distances that would be feasible to reach with a truck and trailer-hitch, but impractical with a tractor.

Further, there exists a need for a bale handling device that can be operated by a single user.

### SUMMARY

An agricultural bale handling device is disclosed, comprising: a frame comprising a pair of side arms laterally spaced by a front connector to receive the circular ends of a bale; each side arm having a gripping element, connected to the respective side arm, in which the gripping element of one side arm is directed towards the gripping element of the other side arm for engaging respective circular ends of the bale between the side arms to mount the bale for rotation relative to the frame.

A method of transporting an agricultural bale is also disclosed, comprising: mounting circular ends of a bale for rotation between a pair of side arms of a frame, in which the pair of side arms are laterally spaced by a front connector of the frame; and moving the bale along a surface by towing the frame.

In some embodiments, the gripping elements each comprise a spike plate for gripping the respective circular end of the bale. The methods and devices disclosed herein may be adapted for a single user to perform and operate.

These and other aspects of the device and method are set out in the claims, which are incorporated here by reference.

### BRIEF DESCRIPTION OF THE FIGURES

Embodiments will now be described with reference to the figures, in which like reference characters denote like elements, by way of example, and in which:

FIG. 1 is a perspective view of an agricultural bale handling device handling an agricultural bale.

FIG. 1A is an expanded view of the areas marked “1A” in FIG. 1.

FIGS. 2A-B are perspective views of spike plates used as the gripping elements in the agricultural bale handling device of FIG. 1.

FIG. 3 is a perspective view of a further agricultural bale handling device handling an agricultural bale.

FIG. 4 is a rear perspective view of the agricultural bale handling device of FIG. 3, with gripping elements indicated by dashed lines.

FIGS. 4A and 4B are expanded views of the areas marked “4A” and “4B” in FIG. 4.

FIG. 5 is a side elevation view, in section, of a vehicle with a ball hitch towing an agricultural bale handling device.

FIG. 6 is a side elevation view of a bale 20 engaged by a gripping element.

FIG. 7 is a side elevation view of a bale 20 being unrolled.

### DETAILED DESCRIPTION

Immaterial modifications may be made to the embodiments described here without departing from what is covered by the claims. A round bale is an agricultural bale that is generally circular in section, having typically been made by a rolling process. The ends of the bales tend to be generally flat so that the bales have an overall cylindrical configuration.

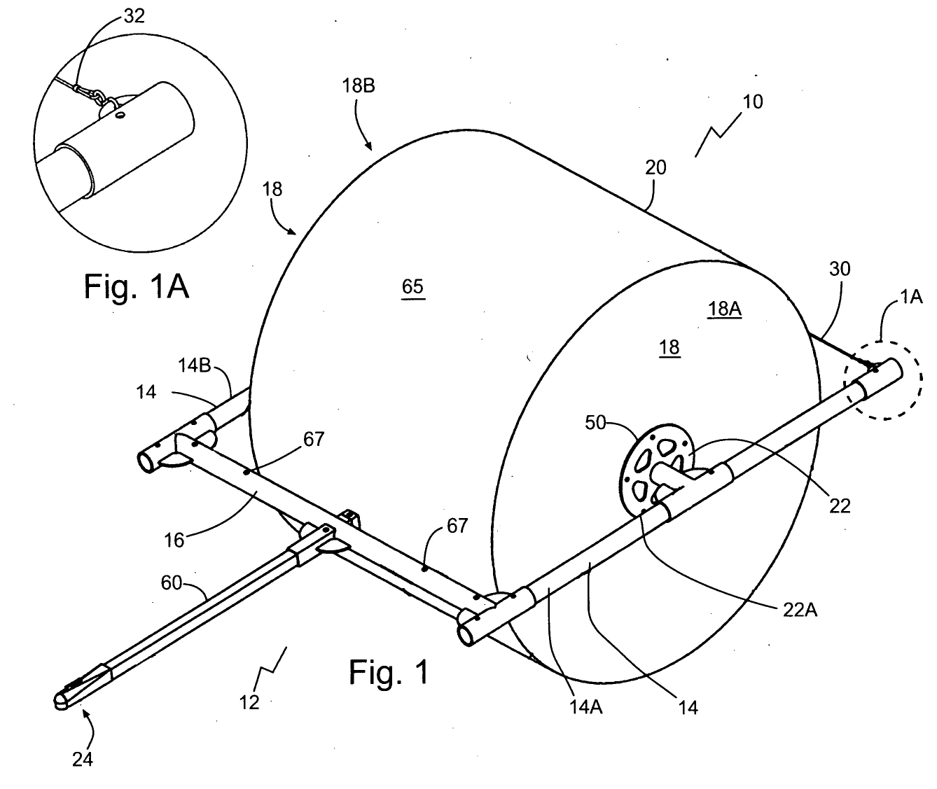

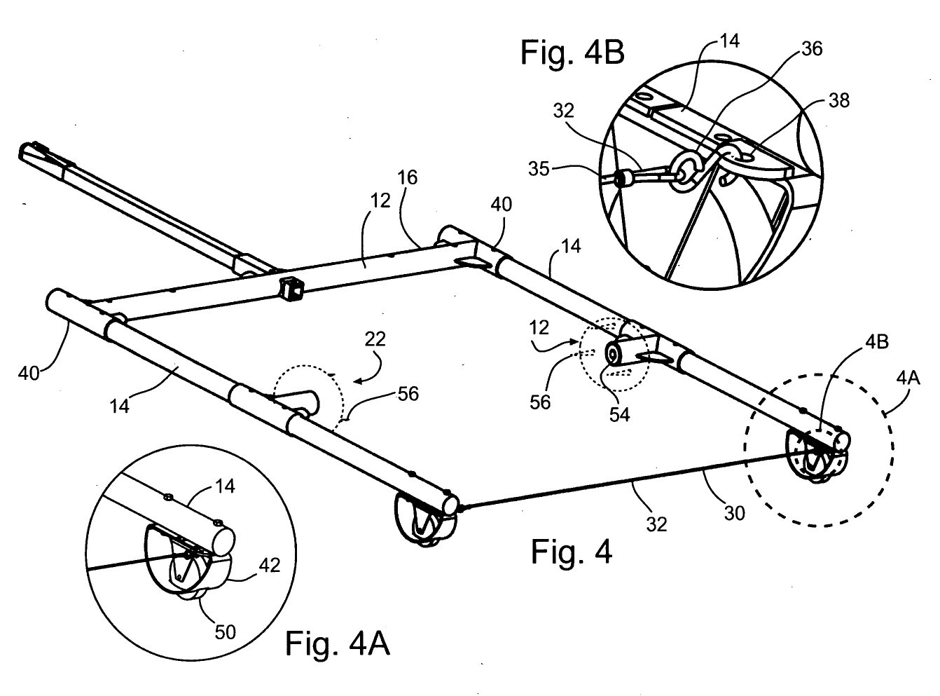

Referring to FIG. 1, an agricultural bale handling device 10 is illustrated, comprising a frame 12, which may be a yoke. Frame 12 comprises a pair of side arms 14, laterally spaced by a front connector 16 to receive the circular ends 18 of a bale 20. Referring to FIGS. 1 and 4, each side arm 14 has a gripping element 22 connected to the respective side arm 14, in which the gripping element 22 of one side arm 14 is directed towards the gripping element 22 of the other side arm 14 for engaging respective circular ends 18 of the 1 bale 20 between the side arms 14 to mount the bale 20 for rotation relative to the frame 12. A suitable agricultural bale may comprise one or more of the following: hay, straw, green feed such as barley, oats, or any harvested crop that is cut and baled.

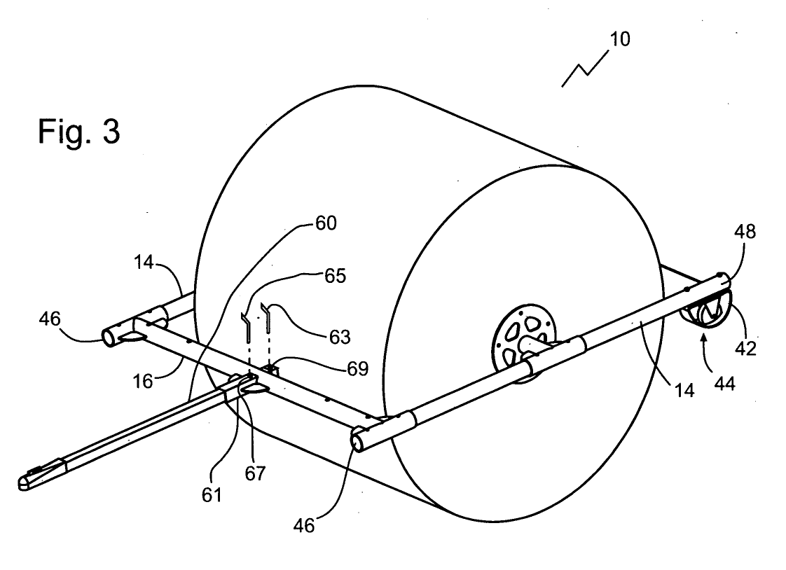

Referring to FIG. 1, the front connector 16 may comprise a rigid beam between the side arms 14 as shown. Referring to FIG. 4, in some embodiments, the frame 12 comprises a rear connector 30 between the side arms 14. The rear connector 30 may act as a stay that pulls together the back ends of the side arms 14 to prevent a side arm 14 from slipping off of a gripping element 22. In further embodiments, one or more of the front connector 16 and the rear connector 30 comprise a strap connector 32, for example one or more of a wire rope, chain, twine, a rope, and a strap, between the side arms 14. In use, if strap connectors are used for the front and rear connectors, then both strap connectors must be tight enough to maintain the pair of arms 14 laterally spaced close enough for the gripping elements 22 to hold the circular ends 18 of a bale 20 in position. FIG. 4B illustrates an examplary strap connector 32, for example a wire rope 35 and hook 36, which connect to a corresponding hole 38 on side arm 14. The rear connector 30 may also be rigid (not shown). Referring to FIG. 3, side arms 14 may mount to front connector 16 at respective front ends 46.

Referring to FIG. 4, the side arms 14 may be adjustable in length. Side arm length adjustment may be carried out by a suitable mechanism, for example by telescopically mounting side arms 14 in mounts 40, for example steel couplers, of front connector 16. In other embodiments, front connector 16 may selectively mount to side arms 14 at various points along the length of side arms 14, much like a pin in hole system. Similarly, the position of gripping elements 22 along the length of side arms 14 may be adjustable. In some embodiments, the lateral separation of the side arms 14 is adjustable in length. All of the adjustment mechanisms discussed may be suitable adjustment mechanisms known in the art. Affording adjustability in the dimensions and locations of the components as discussed above allows frame 12 to be adjusted in size to effectively fit a range of sizes of bales.

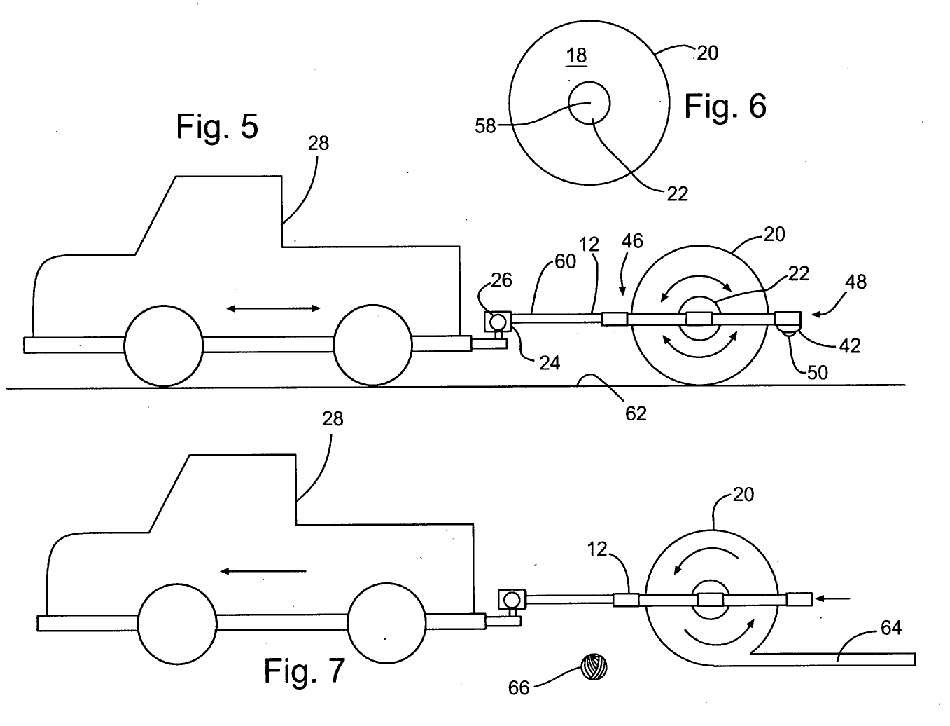

Referring to FIG. 3, each side arm 14 may further comprise a skid element 42, for example a skid plate, connected to a back end 48 of the respective side arm 14. Skid elements 42 allow the frame 12 to slide or roll more easily when hitched and especially when an operator is moving the frame 12 into position alongside a bale 20. Skid elements 42 may also protect side arms 14 from damage during positioning, for example with a vehicle 28 (shown in FIG. 5). Referring to FIG. 5, the use of skid elements 42 can be envisioned if bale 20 is removed, and back ends 48 of frame 12 dragged along the ground. Referring to FIGS. 4A and 5, the skid elements 42 may further comprise ground engaging rolling elements 50, to make frame 12 easier to transport with no bale 20 and also easier to position around a bale 20. A suitable rolling element 50 may be a wheel protruding through a slot opening in the underside of a skid element 42. The wheel and skid combination is the preferred embodiment as it will be useful on hard terrain and as well on soft terrain such as muddy ground or snow covered ground.

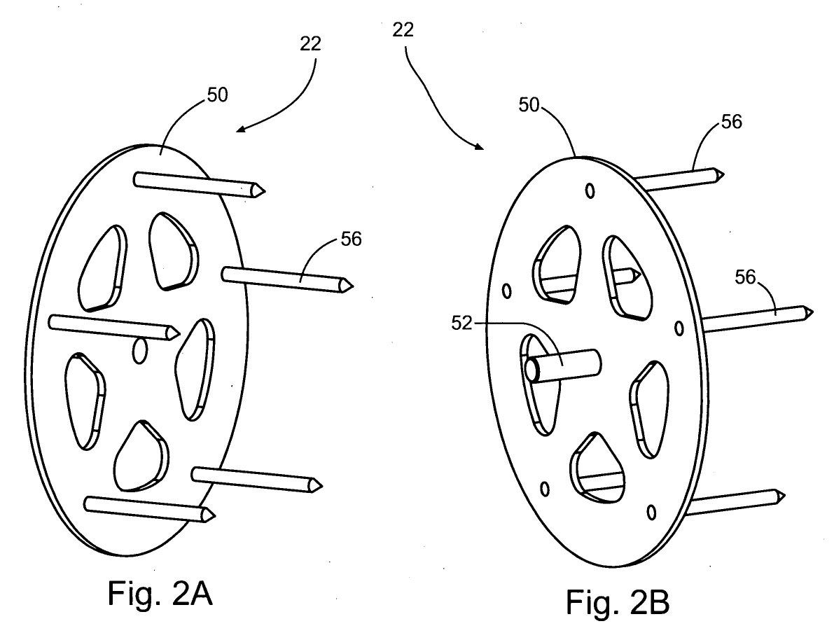

In some embodiments, each gripping element 22 comprises a single spike for piercing and holding a bale 20 in place. Referring to FIG. 1, the gripping elements 22 may be connected for rotation relative to the respective side arms 14. Referring to FIGS. 2B and 4, this may be accomplished by mounting an axle 52 (shown in FIG. 2B) connected to a gripping element 22 into an axle mount, for example a bushing 54 (shown in FIG. 4, may include a bearing) of side arm 14. Other suitable rotation mounting mechanisms may be used, such as by providing axles 52 on side arms 14 for attachment to gripping elements 22. Mounting the gripping elements 22 for rotation allows elements 22 to rotate with bale 20, and is advantageous if gripping elements 22 frictionally grip bale 20. In further embodiments, the gripping elements 22 each comprise a spike plate 50 for gripping the respective circular end 18 of the bale 20. Referring to FIGS. 2A and 2B, a spike plate 50 may have one or more spikes 56 radially spaced from an axis of rotation, for example defined by axle 52) of spike plate 50. This is advantageous when the bale 20 is gripped by the spike plate 50 at the roller axis 58 (shown in FIG. 6), as the spikes 56 will engage the bale 20 in the denser, more compact regions of the bale 20 that are spaced from the roller axis 58. Spikes 56 may be threaded onto spike plate 50.

Referring to FIG. 1, in some embodiments each gripping element 22 is detachable from the respective side arm 14. Referring to FIG. 6, thus a user can attach the gripping elements 22 to bale 20, and then assemble frame 12 (shown in FIG. 1) around elements 22. The bale handler 10 must be attached to the bale 20 before it can be moved. Providing removable gripping elements 22 allows the elements 22 to be manually and accurately set into the centre (shown as roller axis 58) of the bale 20. Referring to FIG. 1, this process may be difficult with non-detachable elements 22, as the weight of the side arms 14 and potentially the frame 12 itself may need to be otherwise lifted, and the side arms 14 may need to be pried open so that the gripping elements 22 extend past the ends 18 of the bale 20. Having detachable gripping elements 22 allow a single user to place the elements 22 and then position the frame 12. Positioning the frame 12 may be done by first slipping one side arm 14 over the axle (axle 52 of FIG. 2B for example) of a placed gripping element 22, and then slipping the other side arm 14 over the axle of the second element 22.

In some embodiments the side arms 14, which may be rails, are made of material that has limited flexibility, for example resilient material. Wood may be used for this purpose, as wood has a degree of flexibility, which makes it easier to stretch the side arms 14 outwards to fit around ends 18 of bale 20. Side arms 14 may also be loosely or pivotally mounted to front connector 16 to allow a degree of lateral freedom to open frame 12 to fit to gripping elements 22.

Referring to FIGS. 1 and 5, the frame 12 may comprise a coupler, such as a socket 24, mounted for example to a drawbar 60. Referring to FIG. 5, socket 24 is for hitching to a tow, for example a ball hitch 26, of a vehicle 28. This allows frame 12 to be towed by any vehicle, for example a truck, with a basic hitch.

Referring to FIG. 1, a method of transporting an agricultural bale 20 is now described. The circular ends 18 of a bale 20 are mounted for rotation between a pair of side arms 14 of a frame 12, the pair of side arms being laterally spaced by a front connector 16, for example a crossbar, of the frame 12. Each side arm 14 may comprise a gripping element 22 as disclosed herein, and mounting may further comprise engaging the circular ends 18 of the bale 20 with the respective gripping elements 22.

Referring to FIG. 6, in embodiments where gripping elements 22 are detachable from side arms 14, gripping elements 22 may be attached to bale 20 first. Elements 22 are then connected to the respective side arms 14. Referring to FIG. 1, the elements 22 may be connected as follows. The frame 12 may be first moved into position with the side arms 14 straddling the bale 20. One side arm 14A may be raised and hung by a rope (not shown) to the axle 52 (shown in FIG. 2B) of the respective gripping element 22A positioned in the bale 20. Next, the other side arm 14B may be raised and the axle 52 of the respective gripping element 22B (shown in FIG. 1) inserted into the side arm 14B. The rope can then be removed from the side arm 14A and the axle 52 of element 22A slipped into the axle mount of side arm 14A. In some embodiments, the rear connector 30, if any, may then be connected.

Referring to FIG. 3, in some embodiments, the coupler is mounted to the front connector 16 for sliding movement. This may be accomplished by connecting the drawbar 60 to a receiver 61, such as a rectangular receiver, in the front connector 16 so that the drawbar 60 may slide backwards and forward in the receiver 61. The receiver 61 may be a rectangular pipe welded through a hole in the front connector 16. A pin 65, such as a hitch or draw pin, may pass through a hole 67 in the receiver 61 and the drawbar 60, in order to fix the drawbar 60 in place. With pin 65 removed, the drawbar 60 is able to slide backwards in the receiver 61 towards the bale 20. There also may be a pin 63 that may pass through a hole 69 in the drawbar 60 at a position located between the bale 20 and the front connector 16. When in place and with pin 65 removed, pin 63 allows the drawbar 60 to slide in the receiver 61, while also preventing the drawbar 60 from pulling out of the receiver 61 when the vehicle advances forwards. With the front pin 65 installed, the operator may keep the vehicle attached to the frame 12 when positioning the frame 12 into the bale 20. If the vehicle is not connected to the frame 12 during positioning, pulling the front pin 65 may make it easier to connect the coupler to the vehicle hitch once the bale 20 is mounted, since the position of the coupler is allowed some sliding play relative to the vehicle hitch.

In some embodiments, the coupler is pivotally mounted to the front connector 16. This feature also makes it easier to attach the coupler to the vehicle hitch, since the drawbar is allowed to pivot laterally. In the embodiment of the handler 10 illustrated in FIG. 3, this is accomplished by loosely positioning the drawbar 60 in a receiver 61 that is capable of fitting a drawbar that has larger outer dimensions than the outer dimensions of the actual drawbar 60 used. Thus, the drawbar 60 is afforded limited pivoting action in the receiver 61.

Referring to FIG. 5, once bale 20 is mounted to frame 12, the bale 20 may then be moved, for example rolled forward, backward, along a surface 62 by towing the frame 12. Because bale 20 is rolled without the need to lift bale 20, substantially less effort may be required. Thus, a suitable power source, such as a horse, an atv, a truck, a car, or even one or more human beings may be used to tow bale 20. Where a vehicle is used to tow the device 10 with the bale 20, the method may further comprise connecting the frame 12 to a trailer hitch 26 of vehicle 28 prior to moving. Many types of hitches are possible, and a ball-hitch is only one example.

Referring to FIG. 7, in some embodiments, bale 20 may be unrolled to create a mat 64. This may be accomplished by removing the wrapping that prevents the bale from unravelling, for example by unstrapping or severing the wrapping. The wrapping may be twine, netting, straps or other suitable types of wrapping. Straps that have been removed from the bale 20 and rolled in a ball 66 for disposal are illustrated in FIG. 7. The bale 20 is then unrolled by towing the frame 12. Unrolling the bale may be desired for activities such as feeding, re-baling, and unraveling straw bales for animal bedding. Should the user wish to feed the bale, he should ensure that the bale will unravel in the desired direction, otherwise he may need to re-attach the handler 10 to move the bale in the other direction. The bale will unravel down nearly to the diameter of the gripping elements 22, at which point the rear connector 30, if any, may be removed and the gripping elements detached and optionally mounted to holes 67 (shown in FIG. 1). The handler 10 can then be dragged or rolled by the vehicle back to retrieve another bale for feeding, or for disconnection from the tow to be ready for future feeding.

During the course of handling a bale 20, other actions may be required that may not be performed by handler 10. For example, a bale may be up-ended onto a flat side of the bale 20, for feeding livestock so that the bale may be easily unraveled by hand and fed. Referring to FIG. 1, the bale 20 may also be laid down onto the bale's round surface 65. The bale 20 may initially be stood up on end 18 in storage or when off-loading from a truck or trailer, and must be laid down on the round surface for attachment to the handler 10. The bale 20 may also be rotated it on its round surface 65, in order to re-orient the bale 20 for attachment to the handler 10. For performing these movements, any number of techniques may be used including pushing the bale 20 with the bumper of a vehicle, moving with a tractor having a front-end loader or bale spike, or using some combination of rope, chain, cable, or hooks, and tugging these with a tow vehicle as is commonly practiced.

In the claims, the word “comprising” is used in its inclusive sense and does not exclude other elements being present. The indefinite article “a” before a claim feature does not exclude more than one of the feature being present. Each one of the individual features described here may be used in one or more embodiments and is not, by virtue only of being described here, to be construed as essential to all embodiments as defined by the claims.

1. An agricultural bale handling device, comprising:
a frame comprising a pair of side arms laterally spaced by a front connector to receive circular ends of a bale;
each side arm having a gripping element, connected to the respective side arm, in which the gripping element of one side arm is directed towards the gripping element of the other side arm for engaging respective circular ends of the bale between the side arms to mount the bale for rotation relative to the frame.

2. The agricultural bale handling device of claim 1 in which the frame comprises a coupler for hitching to a tow.

3. The agricultural bale handling device of claim 2 in which the coupler is mounted to the front connector for sliding movement.

4. The agricultural bale handling device of claim 2 in which the coupler is pivotally mounted to the front connector.

5. The agricultural bale handling device of claim 1 in which the gripping elements are connected for rotation relative to the respective side arms.

6. The agricultural bale handling device of claim 5 in which the gripping elements each comprise a spike plate for gripping the respective circular end of the bale.

7. The agricultural bale handling device of claim 1 in which each gripping element is detachable from the respective side arm.

8. The agricultural bale handling device of claim 1 in which the front connector comprises a rigid beam between the side arms.

9. The agricultural bale handling device of claim 1 in which the frame further comprises a rear connector between the side arms.

10. The agricultural bale handling device of claim 9 in which one or more of the front connector and the rear connector comprise a strap connector between the side arms.

11. The agricultural bale handling device of claim 1 in which the side arms are adjustable in length.

12. The agricultural bale handling device of claim 1 in which the lateral separation of the side arms is adjustable in length.

13. The agricultural bale handling device of claim 1 in which each side arm further comprises a skid element connected to a back end of the respective side arm.

14. The agricultural bale handling device of claim 13 in which the skid elements further comprise ground engaging rolling elements.

15. The agricultural bale handling device of claim 1 further comprising a bale engaged between the gripping elements.

16. The agricultural bale handling device of claim 15 in which a round agricultural bale is engaged on its roller axis by the gripping elements.

17. A method of transporting an agricultural bale, comprising:
mounting the circular ends of a bale for rotation between a pair of side arms of a frame, in which the pair of side arms are laterally spaced by a front connector of the frame; and
moving the bale along a surface by towing the frame.

18. The method of claim 17 in which each side arm comprises a gripping element, connected to the respective side arm, the gripping element of one side arm being directed towards the gripping element of the other side arm, and in which mounting further comprises engaging the circular ends of the bale with the respective gripping elements.

19. The method of claim 18 in which each gripping element is connected for rotation to the respective side arm.

20. The method of claim 17 in which mounting further comprises
engaging the circular ends of the bale with the respective gripping elements; and
connecting each gripping element to the respective side arm.

21. The method of claim 17 further comprising connecting the frame to a hitch of a tow prior to moving, and in which towing further comprises towing with the tow.

22. The method of claim 15 further comprising:
removing the wrapping that prevents the bale from unravelling; and
unrolling the bale by towing the frame.
